(19) United States
(12) Patent Application Publication
(10) Pub. No.: US 2010/0192780 A1
(43) Pub. Date: Aug. 5, 2010

(54) COFFEE PRESS WITH MESH

(75) Inventor: Jorgen Bodum, Meggen (CH)

Correspondence Address: SUGHRUE MION, PLLC, 2100 PENNSYLVANIA AVENUE, N.W., SUITE 800, WASHINGTON, DC, 20037, US

(73) Assignee: PI-DESIGN AG, Triengen (CH)

(21) Appl. No.: 12/669,176

(22) PCT Filed: May 23, 2008
(86) PCT No.: PCT/CH2008/000233

§ 371 Date: Jan. 14, 2010

(30) Foreign Application Priority Data
Jul. 16, 2007 (CH) 01143/07

(51) Int. Cl. A47J 31/20; A47J 31/06

(52) U.S. Cl. 99/297; 99/299

(57) ABSTRACT

The invention relates to a plunger-filter beverage preparation device of the French press coffee maker variety, incorporating a glass vessel (10). In order to prevent glass splinters from flying about in an uncontrolled manner in the event of a breakage of the glass, the glass 23 vessel is surrounded by a retainer (2). Said retainer (2) consists of a bottom section (21) with a lower ring (26), an upper ring (22), and a narrow-mesh (24) extending between them. The retainer preferably expands in diameter from top to bottom.

### TECHNICAL FIELD

The present invention relates to a beverage preparation device comprising a glass vessel and a plunger filter displaceable therein. Beverage preparation devices of this kind are generally referred to in the English speaking area as “French Press”.

### PRIOR ART

So-called “French Press” coffee makers have long been known from the prior art. These comprise a cylindrical glass vessel, in which a plunger filter is displaceable. The plunger filter can be pressed down via a plunger rod guided in the lid of the vessel. For the preparation of coffee, coffee powder is put into the vessel and brewed with hot water. The mixture is left to stand for a few minutes. After this, the plunger filter is pressed down. The plunger filter takes the leached coffee powder with it and thus separates the ready-to-drink coffee from the coffee powder.

In such coffee makers, the glass vessel can burst in the event of improper use. This risk is present, above all, when the plunger filter is pressed down with excessive force. The risk of bursting can be additionally increased if stresses are present in the glass by dint of the production. When bursting, the glass vessel can literally “explode” and shatter into a multiplicity of glass splinters, which, together with the generally hot content of the vessel, fly about in an uncontrolled manner. Thereby, there is a risk of serious injuries.

In the prior art it is known to surround the glass vessel at least in certain areas with a casing. Such a casing here generally serves an aesthetic purpose and is not normally intended to protect from glass splinters. Examples of such casings are given, for example, in the “bodum® 2007/2008” catalogue on pages 18 and 19. Thus, the glass vessel in the product “KENYA” is surrounded by a special-steel casing, which has large oval recesses. In the product “EILEEN”, a special-steel casing is present, which certainly has a multiplicity of smaller recesses. These are not, however, sufficiently small to prevent the flying about of the glass splinters and the uncontrolled splashing of the hot beverage should the glass break. If the glass vessel is fully encased by a casing, on the other hand, it is no longer possible to observe the coffee in the vessel and establish, for example, what quantity of coffee is present.

### DISCLOSURE OF THE INVENTION

An object of the present invention is therefore to define a beverage preparation device with glass vessel and plunger filter displaceable therein, in which the risk of injury from flying glass splinters and liquid splashes in the event of a glass breakage is reduced and which nevertheless allows the beverage present in the vessel to be observed. Furthermore, it should be possible to manufacture the beverage preparation device in a cost-effective manner.

This object is achieved by a beverage preparation device having the features of claim 1. Advantageous embodiments are defined in the dependent claims.

A beverage preparation device according to the invention thus comprises an upwardly open glass vessel having a vessel bottom and a circumferential vessel wall. Arranged in the vessel is a displaceable plunger filter, which is known per se. In addition, a holder for the glass vessel is present. This has as splinter protection a fine mesh, which surrounds at least a part of the vessel wall.

Through the provision of a fine mesh, the smallest glass splinters are effectively prevented from flying away. Spraying liquid is also held at least sufficiently far back from the mesh that it no longer splashes, but runs down the mesh. In this way, the risk of injury in the event of a glass breakage is considerably reduced. At the same time, the holder of the beverage preparation device according to the invention can be very cheaply produced, since no apertures have to be punched out or cut out of a starting material, as is the case in the prior art for the larger recesses which are known there, but rather a mesh material having the appropriate apertures is inserted from the start.

By a fine mesh is meant a mesh or grille made of wire, plastic or a yarn material, the openings in which are smaller than about 5 mm. Preferably, the mesh is produced from a special-steel wire.

In a preferred embodiment, the mesh is held on an upper ring, which surrounds the vessel wall in an upper region. In particular, the mesh can be held between two rings. The holder then therefore comprises
a circumferential lower ring, which surrounds the vessel wall in a lower region; and
a circumferential upper ring, which surrounds the vessel wall in an upper region.

The mesh is connected to the lower ring and the upper ring and surrounds the vessel wall in the region between the lower and upper ring.

The holder also preferably has a bottom, which is connected to the lower ring and, together with the lower ring, forms a holder lower part which receives the vessel bottom. Preferably, the lower section here forms a retaining vessel for outflowing liquid, so that at least a first surge of outflowing liquid in the event of a glass breakage can be captured. To this effect, the lower ring is continuously connected to the holder bottom, so that the ring forms the side wall of the retaining vessel.

While the upper ring normally bears at least in places against the vessel wall in order thus to hold the vessel, the holder, in a preferred embodiment, widens from top to bottom such that the lower ring has a larger (inner) circumference than the upper ring and runs at a distance from the vessel wall. Both rings generally have a circular outline. While the vessel is normally substantially cylindrical, the holder, in this embodiment, has then a substantially frustoconical shape. The mesh hence widens from top to bottom and runs at an increasing distance from the vessel wall. Should the vessel burst, there is hence sufficient space present between vessel and mesh to catch shards and outflowing liquid and, by virtue of its oblique downward path, divert them in the direction of the holder bottom. Even in embodiments without rings and/or holder bottom, it is sensible if the mesh widens from top to bottom and thereby assumes a (preferably increasing) distance from the vessel wall. If the lower section is configured as a collecting vessel, it can also retain, by virtue of the correspondingly enlarged base area of the holder bottom, a larger quantity of liquid. Moreover, the enlarged base area of the holder makes it more difficult for the coffee maker to be tipped over.

The mesh is preferably drawn sufficiently far downward that the plunger filter, in its lowest, fully pressed-down position, is laterally covered (i.e. laterally to the direction in which the filter is pressed down) by the mesh and/or the lower ring.

While the lower section and the upper ring of the holder, in a simple embodiment, are joined together only by the mesh or, if need be, by a handle, the holder, in other embodiments, can have one or more webs which join together the lower ring and the upper ring. The webs can run in a straight line or in a curve.

The mesh is normally cut out of a flat mesh material in a shape corresponding to the development of the finished mesh, is bent into the final shape and is connected, for example welded, to the rings. A joint region (a seam) is hereupon formed, in which two edge regions of the mesh meet. In the joint region, the edge regions can lie edge to edge or can overlap a little. They are generally joined together, for example welded together, in this region. In order to prevent a risk of injury as a result of sharp-pointed wire ends of the mesh in this joint region, the joint region is preferably covered. This function can be realized by a web between the lower and upper ring, which web covers the joint region. Alternatively, a seamlessly produced mesh can also however be used.

The beverage preparation device will generally have a handle. This is expediently attached to the upper ring. It can additionally or instead also be connected to the lower ring.

### BRIEF DESCRIPTION OF THE DRAWINGS

Preferred embodiments of the invention are described below with reference to the drawings, in which:

FIG. 1 shows a schematic side view of a beverage preparation device according to the invention;

FIG. 2 shows a view of the glass vessel with lid and plunger filter;

FIG. 3 shows a view of a variant of the holder in isolation;

FIG. 4 shows a view of the individual parts of the holder; and

FIG. 5 shows a view of the unrolled mesh.

### DETAILED DESCRIPTION OF PREFERRED EMBODIMENTS

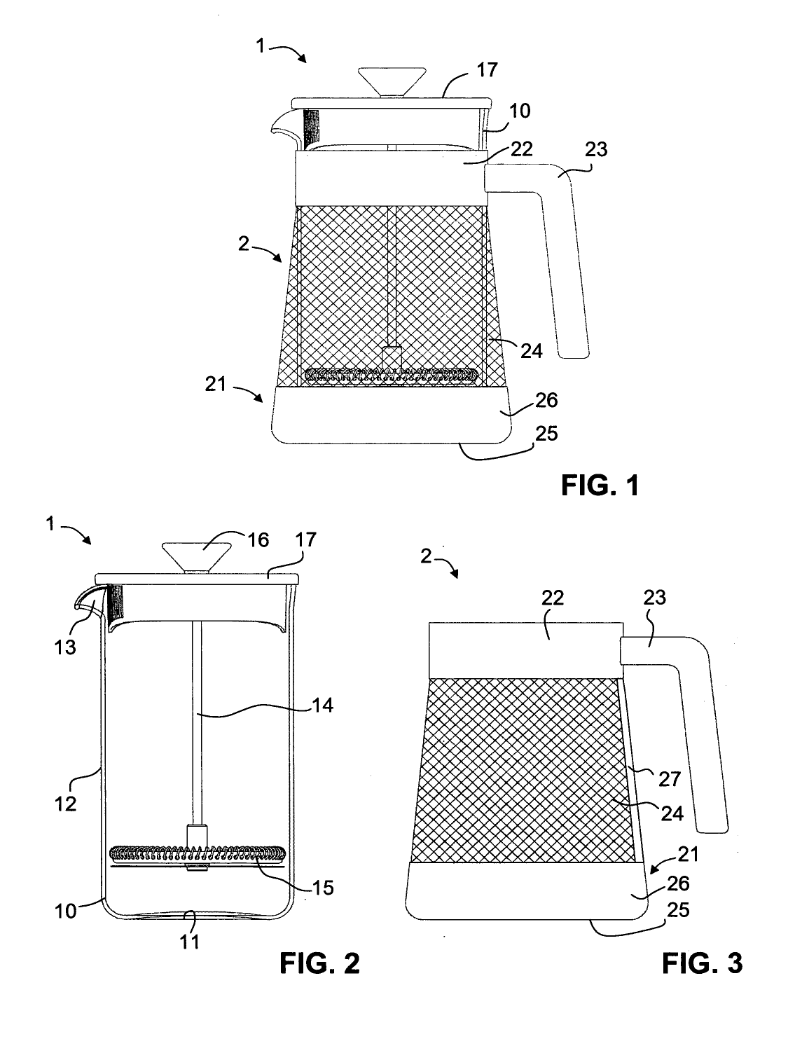

An illustrative embodiment of a beverage preparation device according to the invention is represented in FIG. 1. The beverage preparation device comprises a plunger-filter coffee pot 1, which is represented in isolation in FIG. 2 and has long been known, having a glass vessel 10, a lid 17, and a plunger filter 15 displaceable in the glass vessel 10, which plunger filter is connected to a knob 16 by a plunger rod 14 guided centrally in the lid 17. The glass vessel has a bottom 11, which closes off the vessel in the downward direction, and a circumferential cylindrical side wall 12, on whose upper end there is configured a beak-like spout 13. The vessel is upwardly open and, in its uppermost marginal region, widens slightly to facilitate the introduction of the plunger filter 15.

For use, coffee powder is put into the vessel 10 and infused with hot water. After some time the coffee is stirred, whereupon the leached coffee starts sinking to the bottom 11. Next the plunger filter 15 is inserted and the vessel is closed off with the lid 17. By careful pressure upon the knob 16, the plunger filter is pressed carefully downward. With this, the plunger filter slides along the cylindrical vessel wall 12, takes the coffee grounds with it and thus separates the coffee grounds from the ready beverage. The beverage can then be removed through apertures in the lid via the spout 13. In similar fashion, in place of coffee, tea etc. can also be prepared, generally speaking any beverage in which a solid beverage base substance is leached in a liquid.

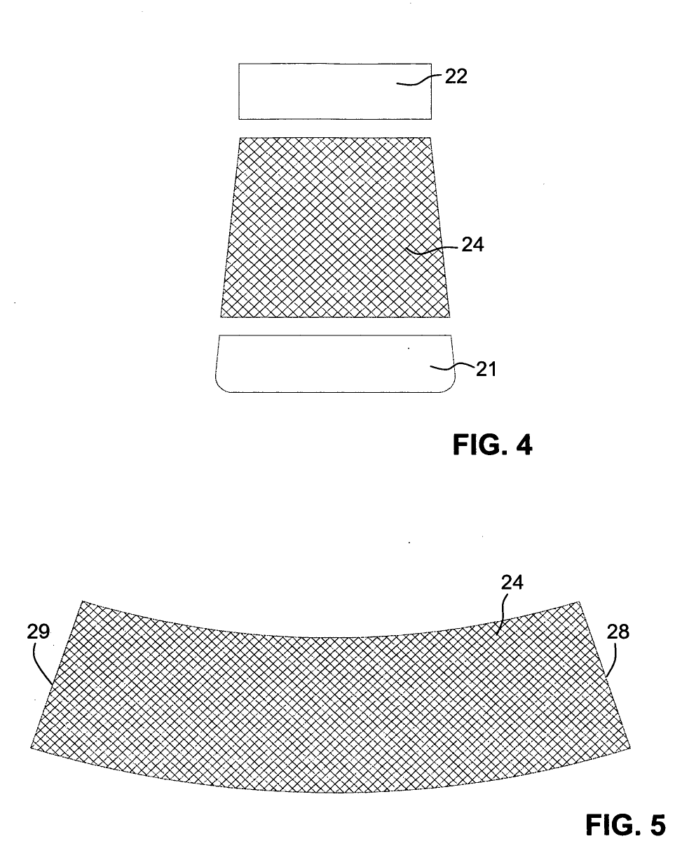

For protection from glass splinters and liquid splashes in the event of a glass breakage, the coffee pot 1 is held in a holder 2. This has a beaker-like lower section 21 having a bottom 25 and a lower ring 26 forming the side wall of the lower section. Attached to an upper ring 22 is a handle 23. The lower ring 26 and the upper ring 22 are connected by a fine mesh 24, which in FIG. 1 is represented purely schematically. Individual parts of the holder are represented in FIG. 4. The lower ring 26 has a larger inner diameter and thus also a larger inner circumference than the upper ring 22. In other words, the holder widens conically from top to bottom and thereby acquires a substantially frustoconical shape. While the upper ring 22 bears snugly against the glass vessel 10 in order to hold this, the vessel, at the lower end, rests only on the bottom 25 of the holder 2 without touching the lower ring 26. In order nevertheless to hold the vessel securely upright, the bottom 25 can contain structures which fix the vessel laterally in the region close to the bottom.

Should the glass vessel break, the lower section 21, the mesh 24 and the upper ring 22 effectively retain the generated glass splinters. Escaping liquid is prevented from spraying out to the side and instead runs down the mesh to collect in the beaker-like lower section 21. The lower section 21 therefore here acts as a collecting vessel for the liquid. In this context, there is no absolute need to ensure that the vessel is perfectly leak-tight, provided only that the very first liquid surge following a glass breakage is prevented from splashing in an uncontrolled manner. In contrast, it is less critical if the liquid then escapes relatively slowly from the lower section 21 or spills over beyond the lower ring should the capacity of the lower section be insufficient to receive the whole of the liquid.

In FIG. 3, a variant of the holder 2 is represented in isolation. In this variant, an additional vertical web 27 is present, which on the rear side of the holder 2, in the region of the handle 23, joins together the two rings 22, 26. On the one hand, the web acts to stabilizing effect, since the mesh is thereby relieved of tensile and compressive forces. On the other hand, it protects the hand of the user from contact with the mesh 24 in the region of the handle.

This is advantageous, in particular, when the mesh has been bent out of a flat material piece into the final shape, as is illustrated in FIG. 5. In FIG. 5, the mesh is represented in the unrolled form as a development. The shape of the mesh corresponds to the development of a truncated cone into the plane. In this form, the mesh is cut out of the starting material. When rolled together into the final, bent form, a seam is formed, at which the lateral edge regions 28, 29 of the mesh butt one against the other or overlap. At this seam, which can also be referred to as the joint region, the user could be injured by sharp-pointed wire ends of the mesh. By covering the seam with the web 27, a corresponding risk of injury is precluded. Moreover, the web covers the often not very esthetically appealing seam also in a visually pleasing manner. However, such a web may also be dispensed with.

The mesh can consist of any chosen suitable material, for example a plastic. Preferably, however, the mesh is produced from a fine special-steel wire. Such a mesh combines several advantages. Given a suitable choice of wire thickness, it is intrinsically sufficiently stable to absorb the tensile and shearing forces which act when the glass vessel is removed from or inserted into the holder. Nor, therefore, are additional webs between the upper and lower ring essential for stabilization purposes. At the same time, such a mesh is sufficiently stable to prevent it from being penetrated by glass splinters. Special steel is also stainless and easy to clean. In a preferred embodiment, the wire thickness is about 0.4 to 0.8 mm, in particular about 0.6 mm. The lower section 21 and the upper ring 22 are preferably also produced from special steel.

While it is indicated schematically in FIGS. 1 and 3 to 5 that the wires forming the mesh run obliquely to the longitudinal axis of the vessel, in particular at an angle of 45 degrees, a different orientation, in particular parallel or perpendicular to the longitudinal axis, is also possible. In place of a mesh having square openings (for example, consisting of a weave of equally spaced wires running perpendicularly to one another), a mesh with other shapes of opening, for example rhombic, and/or a different manufacturing method, for example a knitted mesh, can also be used.

The openings in the mesh are sufficiently small also to retain small glass splinters and prevent splashes. This is achieved if the openings have a maximum size below about 5 mm. In a preferred embodiment, the openings are rhombic in shape and about 3.6 mm large. A different mesh width is also possible, however, as long as this allows an effective splash protection.

While the holder, in the present illustrative embodiments, widens in the downward direction, the holder can also be of cylindrical shape, i.e. of a shape in which the upper and lower ring have the same circumference or diameter. In this case, although the lower section can only conditionally be used as a collecting vessel in the event of a glass breakage, a protection from splinters and splashes is still also given with such a shape.

While a beaker-like embodiment of the lower section of the holder as a collecting vessel is particularly advantageous, other designs of the lower section are also possible. For instance, the lower section does not necessarily need to have a bottom, but instead the lower ring can be connected, for example, to two crisscrossed, suitably bent bridges, which are respectively fastened to diametrically opposing sides of the ring and, in similar fashion to a bucket, hold the bottom of the glass vessel downward. The bridges can be bent in a known manner into feet, as is known, for example, from the product “CHAMBORD” (“bodum® 2007/2008” catalogue, page 9). In such a design, in particular, the lower ring may be dispensed with. If the lower section forms no continuous collecting vessel, a mesh can also be arranged in the region of the vessel bottom.

A large number of further modifications are also possible and the invention is not, of course, restricted to the illustrative embodiments which are represented here.

### REFERENCE SYMBOL LIST

1 plunger-filter coffee pot

10 glass vessel

11 bottom

12 vessel wall

13 spout

14 plunger rod

15 plunger filter

16 knob

17 lid

2 holder

21 lower section

22 upper ring

23 handle

24 mesh

25 bottom

26 lower ring

27 web

28 edge

29 edge

1. A beverage preparation device, comprising
an upwardly open glass vessel having a vessel bottom and a circumferential vessel wall;
a plunger filter displaceable in the glass vessel, and
a holder for the glass vessel,
the holder comprising a fine mesh surrounding at least a part of the vessel wall.

2. The beverage preparation device as claimed in claim 1, wherein the holder has a circumferential upper ring, which surrounds the vessel wall in an upper region, and wherein the mesh is connected to the upper ring and surrounds the vessel wall in a region beneath the upper ring.

3. The beverage preparation device as claimed in claim 2, wherein the holder further has a circumferential lower ring, which is connected to the mesh so that the mesh surrounds the vessel wall in a region between the upper and the lower ring.

4. The beverage preparation device as claimed in claim 3, wherein the holder has a holder bottom, which is connected to the lower ring and, together with the lower ring, forms a holder lower section which receives the vessel bottom.

5. The beverage preparation device as claimed in claim 4, wherein the lower ring is continuously connected to the holder bottom, so that the holder lower section forms a retaining vessel for outflowing liquid.

6. The beverage preparation device as claimed in claim 3, wherein the holder has at least one web joining the lower ring and the upper ring.

7. The beverage preparation device as claimed in claim 6, wherein the mesh has two edge regions, which are joined together in a joint region running from top to bottom, and wherein the joint region is covered by said web.

8. The beverage preparation device as claimed in claim 2, wherein the holder has a handle, which is attached to the upper ring.

9. The beverage preparation device as claimed in claimed 1, wherein the mesh widens from top to bottom, so that it runs at least in certain areas at a distance from the vessel wall.
